(19) United States
(12) Patent Application Publication
(10) Pub. No.: US 2017/0093191 A1
(43) Pub. Date: Mar. 30, 2017

(54) POWER MANAGEMENT SYSTEM

(71) Applicant: APPLE INC., Cupertino, CA (US)

(72) Inventors: Peter Arnold, Cupertino, CA (US); Adam S. Meyer, Cupertino, CA (US); David H. Bloom, San Francisco, CA (US)

(73) Assignee: APPLE INC., Cupertino, CA (US)

(21) Appl. No.: 14/869,813

(22) Filed: Sep. 29, 2015

(51) Int. Cl. H02J 7/00

(52) U.S. Cl. CPC H02J 7/0057; H02J 7/007; H02J 7/0036

(57) ABSTRACT

Systems and methods for managing power across electronic devices and a charge reservoir are discussed herein. A power management system includes a charge reservoir configured to store power, a first charger assembly, and a switch coupled to the charge reservoir and the first charger assembly. The charging monitor may be coupled to the switch. The charging monitor may be configured to query a charge state of a first electronic device, receive the charge state of the first electronic device from the first electronic device, compare the charge state of the first electronic device to a threshold value, and activate the switch when the charge state is less than the threshold value. The activation may cause power to be transferred from the charge reservoir to the first electronic device via the first charger assembly.

### BACKGROUND

Electronic devices are increasingly becoming more ubiquitous in modern day life. It is not uncommon for an individual to have several electronic devices upon which the individual relies for everyday tasks. Such electronic devices include mobile devices such as smart phones, smart watches, tablets, and the like, and conventional household devices such as television sets, appliances, and the like. In order for these electronic devices to operate, power sources provide power in the form of electricity. Examples of such power sources include the utility grid and a charge storage device (e.g., a battery).

For conventional household devices, internal power systems may be constantly connected to the utility grid. Often, such household devices are connected to the utility grid even when not being used. In such cases, power may continue to be drawn from the utility grid, thereby wasting power. For mobile devices, internal batteries may provide power from stored charge. The internal batteries may need to be recharged when depleted such that it may once again provide power to the electronic device. To extend the useable life of the mobile device, an external battery pack may be utilized. The external battery pack may charge the internal battery without having to connect the mobile device to the utility grid.

Conventional battery packs may attempt to charge an internal battery of a mobile device to full capacity regardless of the current charge state of the internal battery. Batteries, however, may require more power to charge as the charge state surpasses a threshold charge state value. For example, a battery may require relatively more power to charge from 80% to a higher charge state than that required for charging up to 80% from a lower charge state. Accordingly, the internal battery may draw more power from the external battery pack to charge the remaining 20%. This creates inefficiencies in power management of the external battery pack, thereby minimizing the effectiveness of the external battery pack to extend the useable life of the mobile device.

Furthermore, greater inefficiencies may result when mobile devices are wirelessly charged from an external battery pack. Wireless charging occurs when a transmitting coil electrically coupled to the battery pack and a receiving coil in the mobile device are positioned to interact with one another. When positioned properly, a time-varying magnetic field generated by the transmitting coil may induce a corresponding current in the receiving coil usable by the mobile device for charging its internal battery. In such instances, the transmitting coil may be constantly generating a time-varying magnetic field even when the mobile device is not present. Power used to generate the magnetic field may be wasted, thereby needlessly draining the external battery pack.

Thus, improvements to the transfer of power for electronic devices are desired.

### SUMMARY

Embodiments provide methods and systems for managing power transfer to (and from) electronic devices in an efficient and power conserving manner.

In some embodiments, a power management system includes a charge reservoir configured to store power, a first charger assembly, and a switch coupled to the charge reservoir and the first charger assembly. The charging monitor may be coupled to the switch. The charging monitor may be configured to query a charge state of a first electronic device, receive the charge state of the first electronic device from the first electronic device, compare the charge state of the first electronic device to a threshold value, and activate the switch when the charge state is less than the threshold value. The activation may cause power to be transferred from the charge reservoir to the first electronic device via the first charger assembly.

In some embodiments, a method of operating a power management system includes querying a charge state of an electronic device, receiving the charge state of the electronic device from the electronic device, determining whether the charge state is less than a threshold value defined by a charge policy, and activating a switch when it is determined that the charge state is less than the threshold value to transfer power to the electronic device from a charge reservoir via a first charger assembly.

In some embodiments, a charging monitor includes a charge enable circuitry configured to activate a power transfer switch upon application of an activation voltage, a device presence switch configured to determine whether an electronic device is configured to receive power; and a controller coupled to the charge enable circuitry and the device presence switch. The controller may be configured to query a charge state of an electronic device, receive the charge state of the electronic device from the electronic device, determine whether the charge state is less than a threshold value defined by a charge policy, and activate a switch when it is determined that the charge state is less than the threshold value to transfer power to the electronic device from a charge reservoir via a first charger assembly, thereby providing power to the electronic device from a charge reservoir via a first charger assembly.

### BRIEF DESCRIPTION OF THE DRAWINGS

FIG. 1 is a simplified diagram illustrating a power management system, according to embodiments of the present invention.

FIG. 2 is a simplified block diagram illustrating a power management system configured for wireless power transfer, according to embodiments of the present invention.

FIG. 3 is a simplified block diagram illustrating a power management system configured for wired power transfer, according to embodiments of the present invention.

FIG. 4 is a simplified block diagram illustrating a power management system coupled to two electronic devices, according to embodiments of the present invention.

FIGS. 5A-5D are simplified block diagrams illustrating an exemplary transfer of power for one electronic device during operation of a power management system, according to embodiments of the present invention.

FIGS. 6A-6C are simplified block diagrams illustrating an exemplary transfer of power for two electronic devices during operation of a power management system, according to embodiments of the present invention.

FIG. 7 is a flow chart for a method of operating a power management system, according to embodiments of the present invention.

FIG. 8 is a simplified block diagram illustrating a charging monitor for a power management system, according to embodiments of the present invention.

### DETAILED DESCRIPTION

Embodiments describe a charging monitor for managing the transfer of power between a charge reservoir and one or more electronic devices in a power management system. The charging monitor may control how much power is transferred between the charge reservoir and the electronic devices by controlling a period of time when power is transferred. By selectively providing power when power is needed or being used, the charging monitor may minimize the wasting of power while ensuring that internal batteries in electronic devices remain sufficiently charged.

According to embodiments, the charging monitor may communicate with an electronic device. For instance, the charging monitor may be communicatively coupled to the electronic device such that it may query and receive a charge state of the electronic device. Thereafter, the charging monitor may change (e.g., stop or start) the transfer of power to the electronic device based upon the received charge state. The charging monitor may transfer power to the electronic device according to a charge policy. The charge policy may be determined by a user. Thus, a user may control the rules governing how the charging monitor transfers power. Further details of the power management system are discussed further herein.

### I. Power Management System

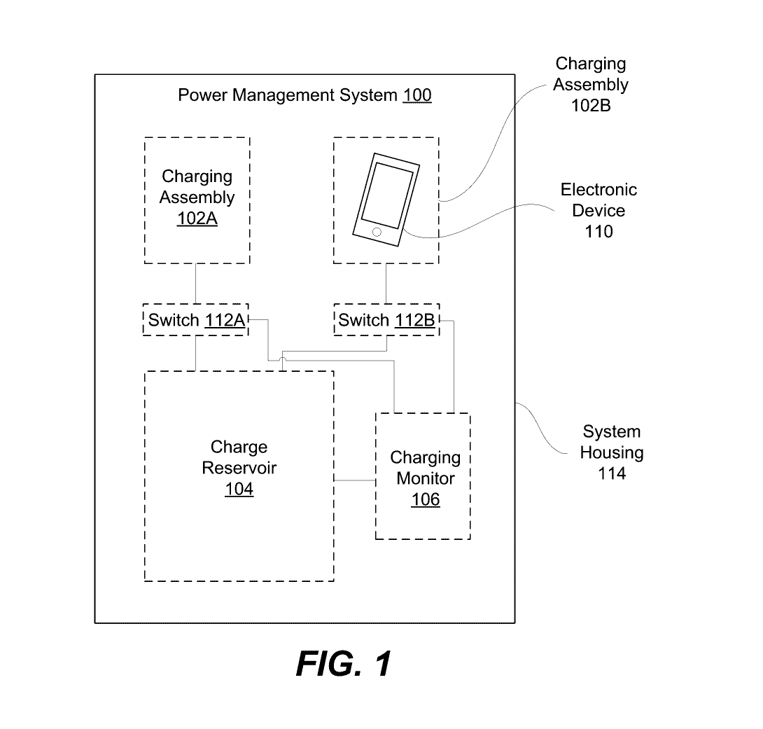

FIG. 1 is a simplified diagram illustrating a broad overview of a power management system 100 in accordance with embodiments of the present invention. Power management system 100 includes one or more charging assemblies, such as charging assemblies 102A and 102B. Each charging assembly 102A and 102B may include an electronic circuit configured to transfer power to an electronic device 110, such as a smart phone, smart watch, tablet, and the like.

Power provided to the charging assemblies 102A and 102B may be regulated by switches 112A and 112B. When activated, switch 112A may allow power to transfer to charging assembly 102A and/or switch 112B may allow power to transfer to charging assembly 102B, by electrically coupling charge reservoir 104 to charging assembly 102A and/or charging assembly 102B. As described in further detail herein and shown in FIG. 1, when electronic device 110 is present, charge reservoir 104 may transfer power to charging assembly 102B. The power transferred to charging assembly 102B may then be transferred by charging assembly 102B to electronic device 110 (e.g., via wireless or wired power transfer). As a result, an internal battery in electronic device 110 may be charged using power transferred by charge reservoir 104.

In embodiments, charging assembly 102A and 102B may be configured to transfer power to an electronic device. Depending on system design, charging assembly 102A and 102B may be configured to transfer power in different ways. For example, charging assembly 102A and 102B may be configured to wirelessly transfer power to electronic device 110, as illustrated in FIG. 1. In such configurations, charging assemblies 102A and 102B may include transmitter coils operable to generate time-varying magnetic fields. The time-varying magnetic fields may induce a corresponding current in receiving coils of electronic devices when the receiving coils are placed in alignment with charging assemblies 102A and 102B. For instance, a current may be induced in a receiving coil disposed in electronic device 110 when electronic device 110 is placed against charging assembly 102B such that the receiving coil in electronic device 110 is aligned with the transmitting coil in charging assembly 102A.

For embodiments where power management system 100 is configured for wired power transfer, charging assemblies 102A and 102B may include hardware configured for wired charging, such as an electrical circuit configured to provide and receive power through a wire cable (not shown in FIG. 1). In such embodiments, the wire cable may physically connect charging assembly 102A with electronic device 110 such that power may transfer from charging assembly 102B and electronic device 110 through the wire cable.

In embodiments, a charging monitor 106 is coupled to switches 112A and 112B. Charging monitor 106 may control the transfer of power between charge reservoir 104 and charging assemblies 102A and/or 102B by activating corresponding switches 112A and 112B. When activated, switches 112A and/or 112B may close, allowing power to transfer from charge reservoir 104 to charging assemblies 102A and/or 102B through corresponding switches 112A and 112B. Likewise, if deactivated, switches 112A and 112B may open, preventing transfer of power from charge reservoir 104 to charging assembly 102A and/or 102B. Thus, charging monitor 106 can selectively provide power to specific charging assemblies, the power being usable to charge one or more electronic devices.

According to embodiments of the present invention, charging monitor 106 may be communicatively coupled to electronic device 110. Thus, charging monitor 106 may query and receive information from electronic device 110. For instance, charging monitor 106 may query and receive a present amount of charge stored in the internal battery of electronic device 110 (i.e., a “charge state” of electronic device 110). The querying and receiving may occur periodically or continuously and may be performed via wireless communication, such as a Bluetooth connection, wireless fidelity (WiFi) connection, beacon transmissions, and the like. Charging monitor 106 may use the charge state of electronic device 110 when managing the transfer of power to selectively charge electronic device 110, thereby minimizing the wasting of power as will be discussed further herein.

As shown in FIG. 1, the different components of power management system 100 (e.g., charging assembly 102A, charging assembly 102B, charge reservoir 104, charging monitor 106, and switch 112) may be embedded within a system housing 114. System housing 114 may be a rigid structure within which the different components may be embedded. Additionally, system housing 114 may be a non-rigid enclosure having pockets or compartments within which the different components may be contained. Accordingly, the different components are illustrated with dashed lines. Embodiments, however, are not limited to such configurations. Other embodiments may have one or more components located outside of system frame 114. For instance, charge reservoir 104 may be disposed outside of system frame 114. In another instance, charging monitor 106 may be disposed outside of system 114. Additionally, although FIG. 1 illustrates only two charging assemblies 102A and 102B, embodiments having more or less charging assemblies are envisioned herein as well. As an example, power management system 100 may have three, four, or any suitable number of charging assemblies configured to charge electronic devices. One skilled in the art will understand that power management system 100 in FIG. 1 is merely one embodiment of the present invention and that other configurations that do not depart from the spirit and scope of the present invention are envisioned herein.

The different components in FIG. 1 are interconnected in a way that enables charging monitor 106 to control transfer of power between the different components. For clarity and ease of discussion, block diagrams are discussed hereinafter to describe the different connections within a power management system.

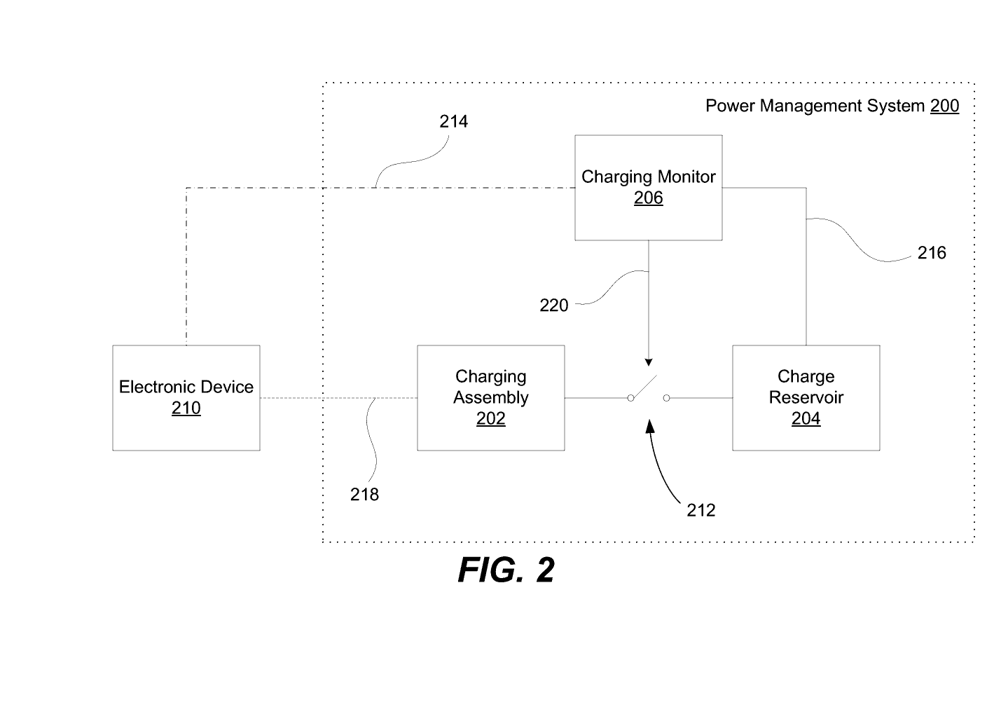

FIG. 2 is a block diagram illustrating an exemplary power management system 200 according to embodiments of the present invention. The block diagram of FIG. 2 more clearly illustrates the connections between the different components in a power management system. As shown, power management system 200 may include a charge reservoir 204. In embodiments, charge reservoir 204 may be a component capable of supplying charge such as an energy storage device (e.g., a battery) or the utility grid. The energy storage device may be a lithium ion battery or any other suitable battery well known in the art.

Power management system 200 may further include a charging assembly 202. In some embodiments, charging assembly 202 is electrically coupled to charge reservoir 204 by way of a switch 212 disposed along a conductive path connecting charge reservoir 204 to charging assembly 202. Switch 212 may enable and disable transfer of power between charging assembly 202 and charge reservoir 204 depending on whether switch 212 is activated. For instance, power may transfer when switch 212 is activated (i.e., closed); and power may not transfer when switch 212 is not activated (i.e., open). In certain embodiments, switch 212 may be any suitable electrical component that allows the selective transfer of power between charge reservoir 204 and charging assembly 202. For instance, switch 112 may be a power transistor that allows power to transfer across its source and drain when its gate is activated. The power transistor may be a metal oxide semiconductor field effect transistor (MOSFET), bipolar junction transistor (BJT), and the like.

In embodiments, a charging monitor 206 may be operatively coupled to switch 212 through an activation channel 220. Charging monitor 206 may be configured to operate switch 212 to control the transfer of power between charging assembly 202 and charge reservoir 204. As an example, in embodiments where switch 212 is a power transistor, charging monitor 206 may be coupled to the gate of switch 212 such that when a voltage is applied through activation channel 220, switch 212 is turned ON (i.e., activated), thus allowing power to transfer between the source and drain nodes of switch 212. Conversely, when no voltage is applied through activation channel 220, switch 212 may be turned OFF (i.e., deactivated), thereby preventing power from transferring between the source and drain nodes of switch 212. In certain embodiments, charging monitor 206 may include a processor configured to control switch 212. For instance, charging monitor 206 may include any suitable integrated circuit, such as a microcontroller, application-specific integrated circuit (ASIC), or the like.

Charging monitor 206 may be communicatively coupled to charge reservoir 204 via reservoir channel 216. Reservoir channel 216 may be a connection to charge reservoir 204 that allows charging monitor 206 to be aware of a charge state of charge reservoir 204. For instance, reservoir channel 216 may be a communication channel through which charging monitor 206 can query and receive a charge state of charge reservoir 204. In other instances, reservoir channel 216 may be a connection line for a voltage meter configured to measure the voltage output of charge reservoir 204 through reservoir channel 216. Accordingly, charging monitor 206 can utilize reservoir channel 216 to determine a charge state of charge reservoir 204. In embodiments, charging monitor 206 may selectively allocate charge for an electronic device 210 depending on the amount of charge in charge reservoir 204. In embodiments, charging monitor 206 may also selectively allocate charge between electronic device 210 and other electronic devices (not shown) according to a charge policy, as will be discussed further herein.

In some embodiments, reservoir channel 216 may be a connection through which power may be transferred. For instance, charging monitor 206 may receive power from charge reservoir 204 through reservoir channel 216. By drawing power from charge reservoir 204, charging monitor 206 may be operable when charger reservoir 204 has stored charge.

Electronic device 210 may be configured to receive power from and/or provide power to charging assembly 202. Electronic device 210 may be any suitable device that operates by consuming electricity. As an example, electronic device 210 may be a mobile device such as a smart phone, a smart watch, a tablet, or the like, or a conventional household device such as a television set, an appliance, or the like. When power is transferred to charging assembly 202 from charge reservoir 204, charging assembly 202 may in turn transfer power to electronic device 210. Accordingly, electronic device 210 may be charged by power transferred from charge reservoir 204.

According to embodiments of the present invention, charging monitor 206 may be communicatively coupled to electronic device 210 via a communication channel 214. In certain embodiments, communication channel 214 may be a wired connection, such as a cable connection. In other embodiments, communication channel 214 may be a wireless connection, such as a Bluetooth connection, a WiFi connection, or the like. Communication channel 214 may enable charging monitor 206 to query and receive charge state information from electronic device 210 to better manage the transfer of power between charge reservoir 204 and charging assembly 202, as will be discussed further herein.

In embodiments, charging monitor 206 may manage the transfer of power between electronic device 210 and charge reservoir 204 according to a charge policy. The charge policy may be one or more rules in the form of an algorithm that instructs charging monitor 206 on when power is to be transferred to electronic device 210. For instance, the charge policy may allow a transfer of power to electronic device 210 until an internal battery of electronic device 210 reaches a threshold charge state value, at which point the transfer of power may change (e.g., stop). The threshold charge state value may be a specific amount of charge that is set according to a desired goal. As an example, if the desired goal is to maximize power transfer efficiency, then the threshold charge state value may be set to 80% of the charge capacity of the internal battery. As discussed herein, 80% of the charge capacity of the internal battery may be the point at which charging efficiency begins to decrease when attempting to fully charge the internal battery to 100%. If the desired goal is instead maximum charging, then the threshold charge state value may be set at 100%.

According to embodiments, the charge policy may be user-adjustable, meaning a user may alter the parameters of the charge policy, such as the threshold charge state value. The user may alter the charge policy by interacting with electronic device 210. Electronic device 210 may then communicate with charging monitor 206 through communication channel 214 to adjust the charge policy which, in some embodiments, may be stored in charging monitor 206 or in an accessible storage device. Accordingly, charging monitor 206 may be highly adaptable to different goals desired by a user.

Electronic device 210 may receive power from charge reservoir 304 through charging assembly 202. Depending on the configuration of power management system 200, electronic device 210 may be charged via a wireless charging method or a wired charging method. As a result, charging assembly 202 may comprise hardware and/or software configured to facilitate the type of charging implemented in power management system 200.

A. Wireless Power Management System

With further reference to FIG. 2, power management system 200 is configured as a wireless power management system according to embodiments of the present invention. Accordingly, charging assembly 202 may be configured to wirelessly charge electronic device 210 through wireless transfer connection 218. To indicate the method of wireless charging, wireless transfer connection 218 is illustrated in FIG. 2 as a dashed line.

In such configurations, charging assembly 202 can include a circuit configured to wirelessly charge electronic device 210. For example, charging assembly 202 may be a coil of wire designed to generate a time-varying magnetic field when an alternating current flows through the coil. The time-varying magnetic field may induce a corresponding current in a receiving coil. The receiving coil may be disposed within electronic device 210, and the induced current in the receiving coil can be used by electronic device 210 to charge its internal battery.

Existing chargers for wireless power transfer, in general, may waste a high amount of power. This is because charging assemblies may constantly generate a time-varying magnetic field regardless of whether a device with a receiving coil is present to receive the generated power. Power may thus continually be consumed even when no device is present, thereby unnecessarily drawing energy from the power source (e.g., the energy grid, an external battery, etc.) coupled to the charger. Additionally, chargers may constantly generate a time-varying magnetic field regardless of whether a device is at full charge. In such cases, power may continually be consumed even when the device is unable to receive more charge, thereby wasting a substantial amount of power. Furthermore, chargers may charge a battery to maximum capacity without regard for the relatively lower charging efficiency when a charge state of the battery is greater than threshold (e.g., 80%) of its charge capacity.

To avoid wasting this power, switch 212 may be implemented in embodiments of the present invention to cease power transfer to charging assembly 202. Switch 212 may be deactivated when no electronic device 210 is present, or when electronic device 210 informs charging monitor 206 that its internal battery is full of charge. Additionally, switch 212 may be deactivated when electronic device 210 informs charging monitor 206 that its internal battery charge level is above a threshold such as 80% full. When switch 212 is deactivated, charging assembly 202 may not receive power from charge reservoir 204, and may thus stop generating the time-varying magnetic field. As a result, a wasting of power may be substantially minimized, if not entirely prevented.

Preventing the wasting of power may also be achieved in wired power management systems, as discussed herein.

B. Wired Power Management System

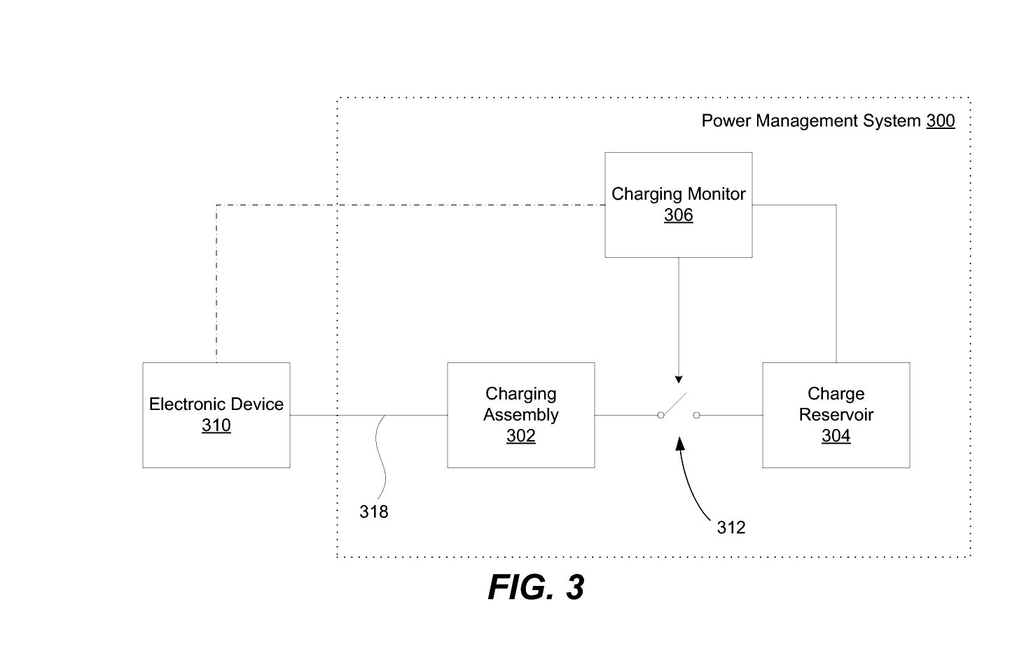

FIG. 3 is a simplified block diagram illustrating a power management system 300 configured as a wired power management system according to embodiments of the present invention. Because power management system 300 is a wired power management system, charge assembly 302 may be configured to charge electronic device 310 through a wired transfer connection 318 shown as a solid line in FIG. 3.

In such configurations, charging assembly 302 is a circuit that is configured to charge electronic device 210 via a wired transfer connection 318. Wired transfer connection 318 may be any suitable physical connection capable of providing a channel through which power may transfer. As an example, wired transfer connection 318 may be a conductive wire, a cable containing one or more conductive wires, and the like. Charging assembly 302 may be a power circuit configured to transfer power through, and receive power from, wired transfer connection 318. For instance, charging assembly 302 may include various power management components, such as alternating current (AC) to direct current (DC) converters, power amplifiers, resistors, capacitors, and the like. The power circuit may regulate power transferred to and/or from electronic device 310 by way of wired transfer connection 318.

Like wireless power management systems, wired power management systems may also waste power. As an example, wired electronic devices such as television sets and appliances are typically connected to a charge reservoir, such as a local utility grid. The wired devices may be constantly connected to the utility grid even when they are turned off Even though the devices are turned off, power may still be drawn from the power grid, thereby wasting power. To minimize such wasting of power, switch 312 may be implemented to cease power transfer to charging assembly 302. Switch 312 may be deactivated when electronic device 310 is turned off, thereby preventing power from flowing to electronic device 310. Electronic device 310 may thus stop drawing power from charge reservoir 304. As a result, the wasting of power may be substantially minimized, if not entirely prevented.

C. Multiple Electronic Devices

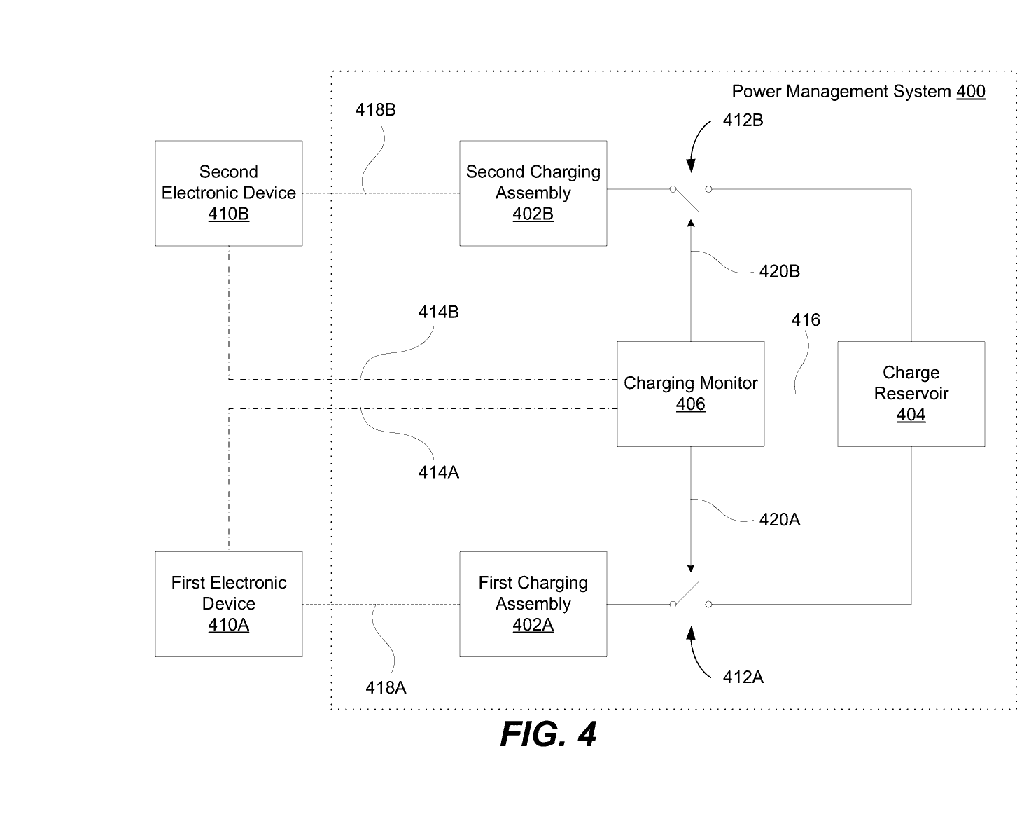

FIGS. 2 and 3 illustrate power management systems 200 and 300 configured to transfer power with one electronic device. Embodiments, however, are not limited to such configurations. Power management systems may be configured to transfer power in systems with more than one electronic device, as shown in FIG. 4.

FIG. 4 illustrates a power management system 400 configured to transfer power with two electronic devices: a first electronic device 410A and a second electronic device 410B. In some embodiments, the number of charging monitors 406 and charge reservoirs 404 implemented in power management system 400 may be independent of the number of electronic devices 410 capable of exchanging power with power management system 400. That is, the number of charging monitors 406 and the number of charge reservoirs 404 may each be more, equal to, or less than the number of electronic devices 410 capable of exchanging power with power management system 400. As an example, power management system 400 may include a single charging monitor 406 and a single charge reservoir 404 even though power management system 400 is capable of transferring power with two electronic devices 410A and 410B.

The number of charging assemblies 402 and switches 412, on the other hand, may correspond to the number of electronic devices 410 with which power management system 400 is capable of transferring power to (and/or receiving power from). In other words, the number of charging assemblies 402 and the number of switches 412 may be equal to the number of electronic devices 410 capable of transferring power with power management system 400. This is because the number of charging assemblies 402 may determine the number of electronic devices 410 that are capable of transferring power with power management system 400 at one time. Each charging assembly 402A and 402B may couple to respective electronic devices 410A and 410B. As an example, first and second charging assemblies 402A and 402B may be configured to transfer power with first and second electronic devices 410A and 410B, respectively. It is to be appreciated that coupling in wireless power management systems, such as power management system 400, may be performed by placing electronic devices 410A and/or 410B in proximity to first and/or second charging assembly 402A, respectively, such that magnetic fields generated by charging assemblies 402A and 402B may induce a corresponding current in a receiver coil in electronic devices 410A and 410B.

In embodiments, charging assemblies 402A and 402B may be generic charging assemblies that can transfer power with different electronic devices. For instance, charging assemblies 402A and 402B may couple to either of first electronic device 410A and second electronic device 410B. As illustrated in FIG. 4, first and second charging assemblies 402A and 402B are configured to operate with first and second electronic devices 410A and 410B, respectively, for ease of description. One skilled in the art will understand that the configuration of first and second electronic devices 410A and 410B may be interchangeable such that first electronic device 410A may be coupled to second charging assembly 402B and second electronic device 410B may be coupled to first charging assembly 402A, without departing from the spirit and scope of the present invention.

The operation of power management system 400 may be similar to the operation of power management system 200 and 300 discussed herein. That is, charging monitor 406 may be configured to manage the transfer of power between charge reservoir 404 and first and second electronic devices 410A and 410B. Charging monitor 406 may control the transfer of power by activating and deactivating switches 412A and 412B according to a charge policy by applying voltage to switches 412A and 412B through activation channels 420A and 402B, respectively. Communication channels 414A and 414B allow charging monitor 406 to query and receive information from first and second electronic devices 410A and 410B, respectively, to manage the transfer of power through power management system 400 by selectively activating and deactivating switches 412A and 412B. In embodiments, charging monitor 406 may cause power to transfer from charge reservoir 404 to first and/or second electronic devices 410A and 410B. Additionally, charging monitor 406 may cause power to transfer from second electronic device 410B to first electronic device 410A, and vice versa.

In embodiments, the charge policy may be similar to the charge policy for maximizing power transfer efficiency as discussed in FIG. 2. For instance, the charge policy may be configured to transfer power from charge reservoir 404 to first and/or second electronic devices 410A and 410B in a way that minimizes waste of power. Alternatively, the charge policy may be more suitable for situations where more than one electronic device is coupled to power management system 400. As an example, the charge policy may be configured to transfer power between first electronic device 410A and second electronic device 410B. The charge policy may be particularly useful if charge reservoir 404 is depleted. That way, one of first or second electronic device 410A or 410B may be used as a charge source for the other device. For example, the charge policy may transfer power from second electronic device 410B to first electronic device 410A, as will be discussed further herein.

### II. Transfer of Power

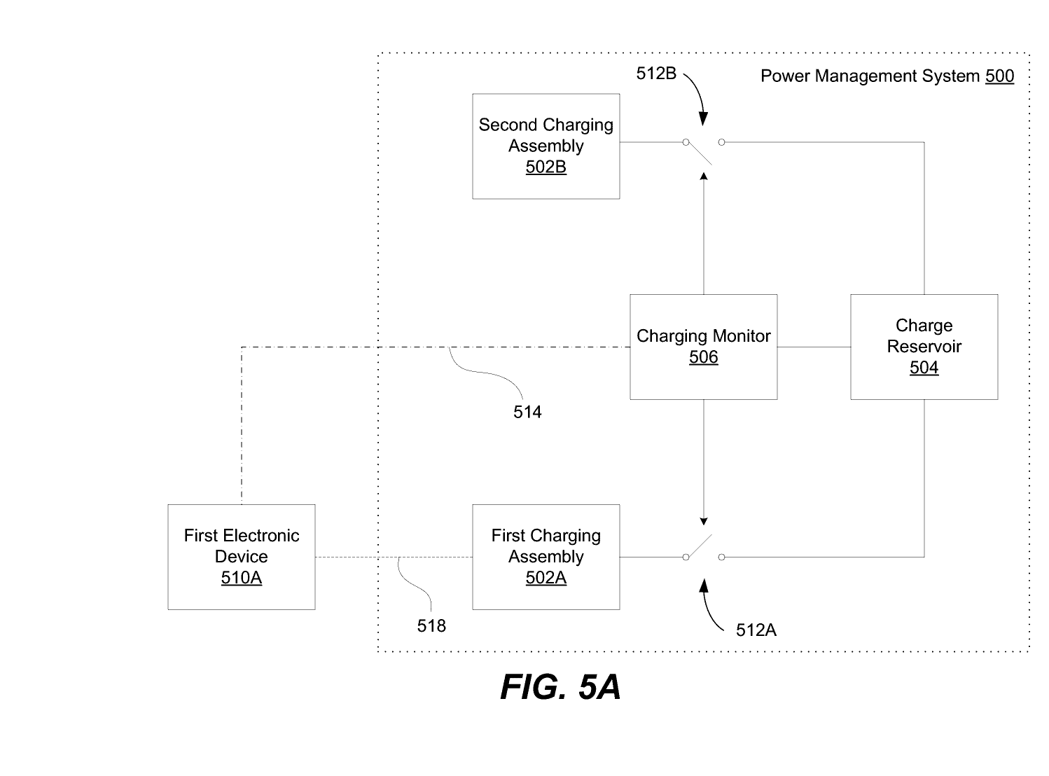

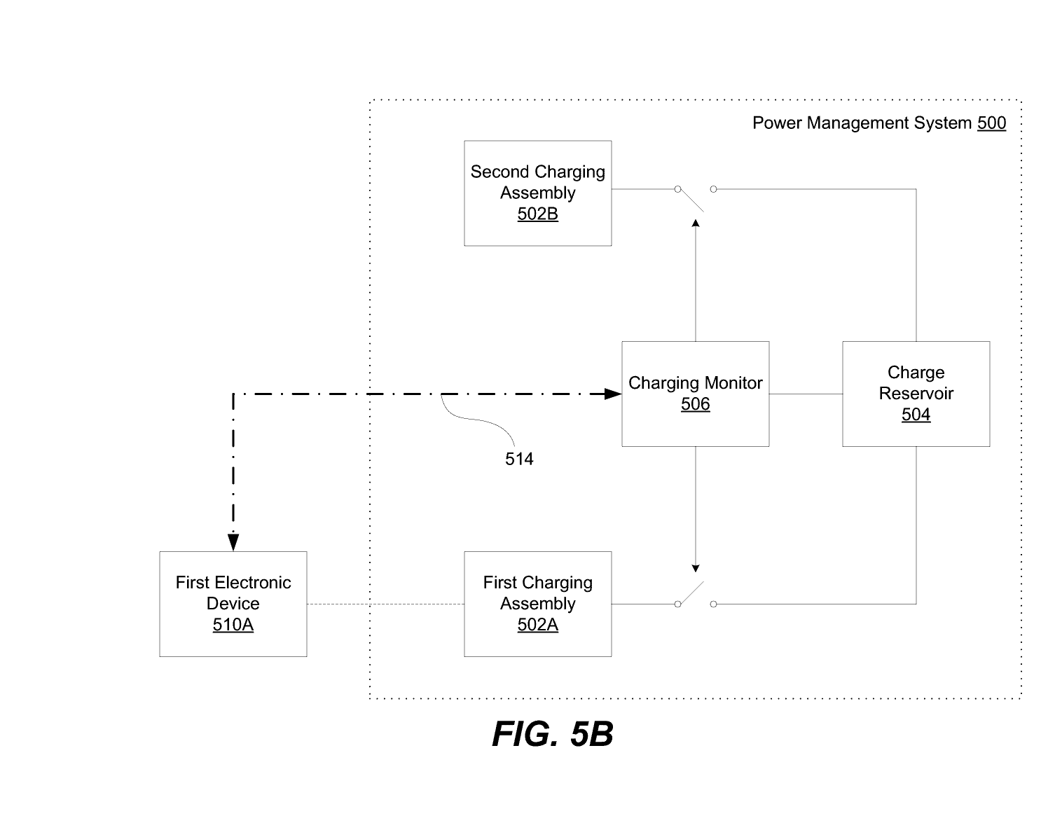

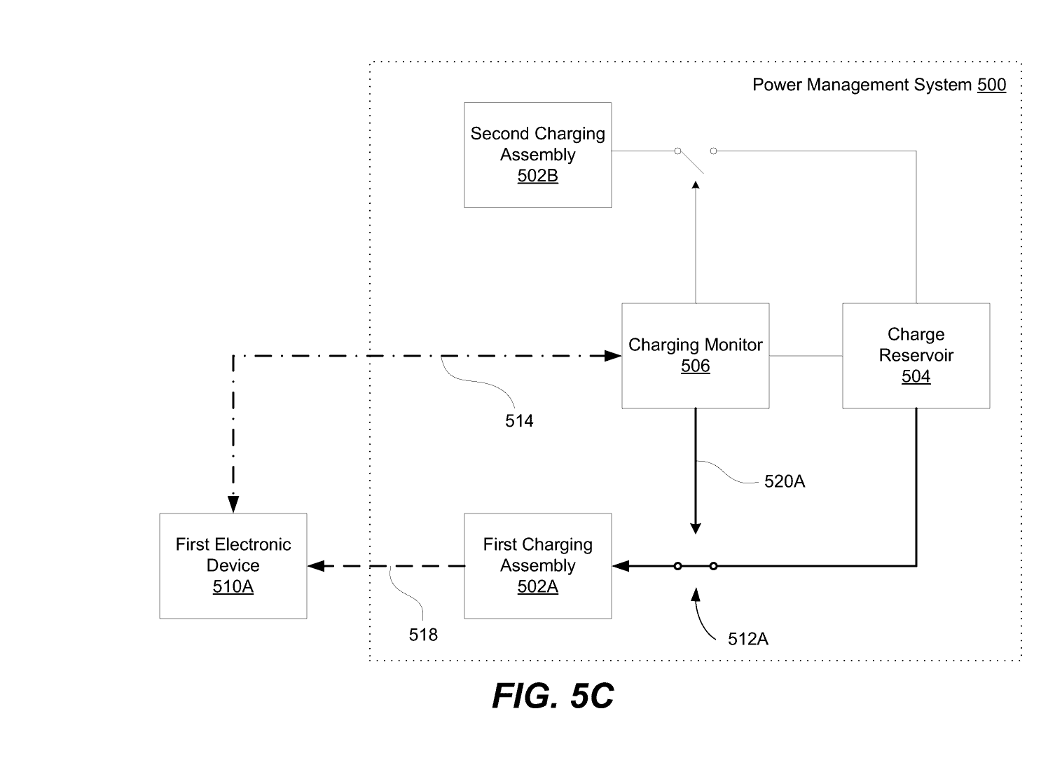

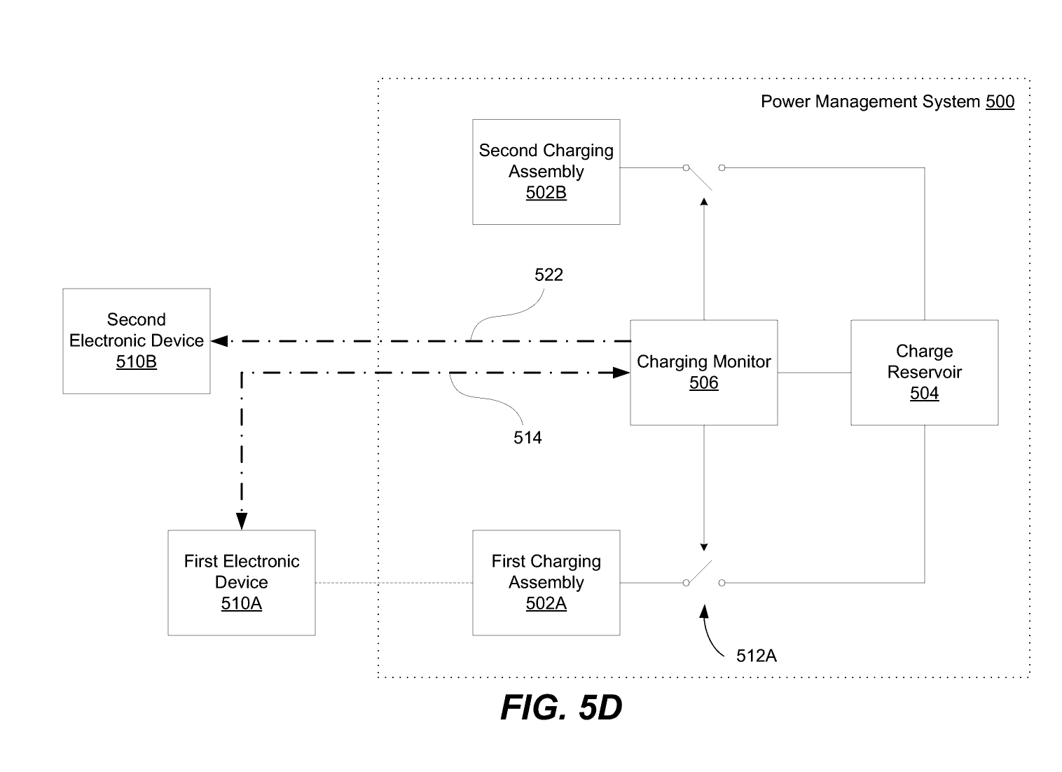

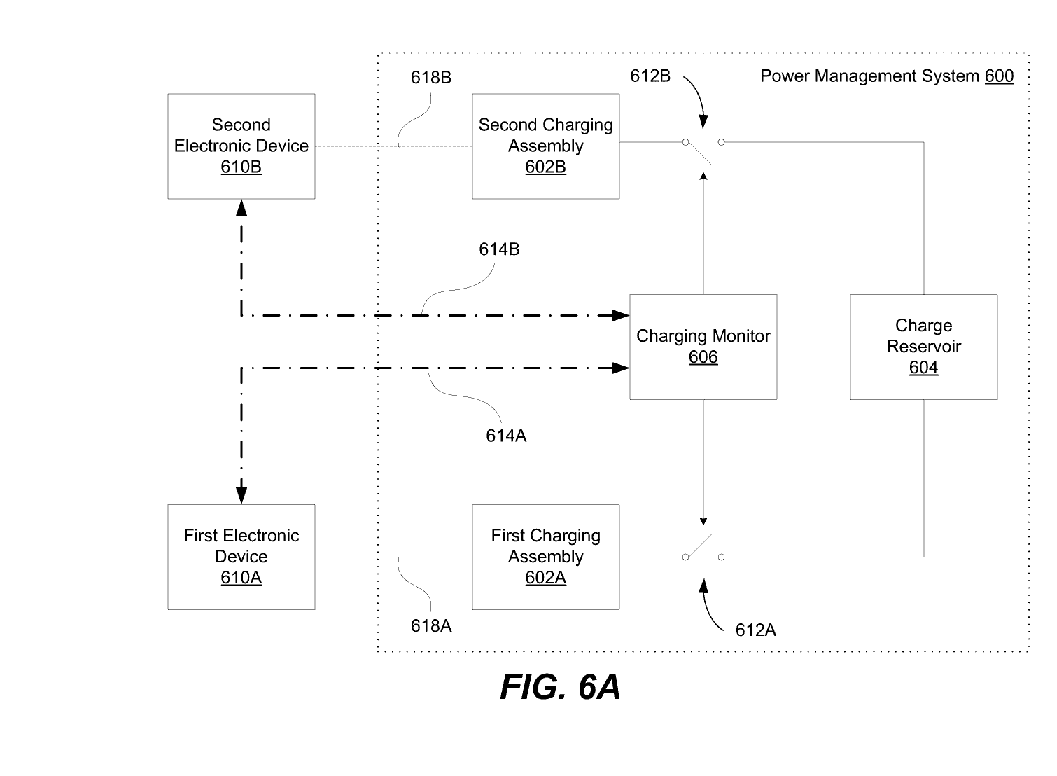

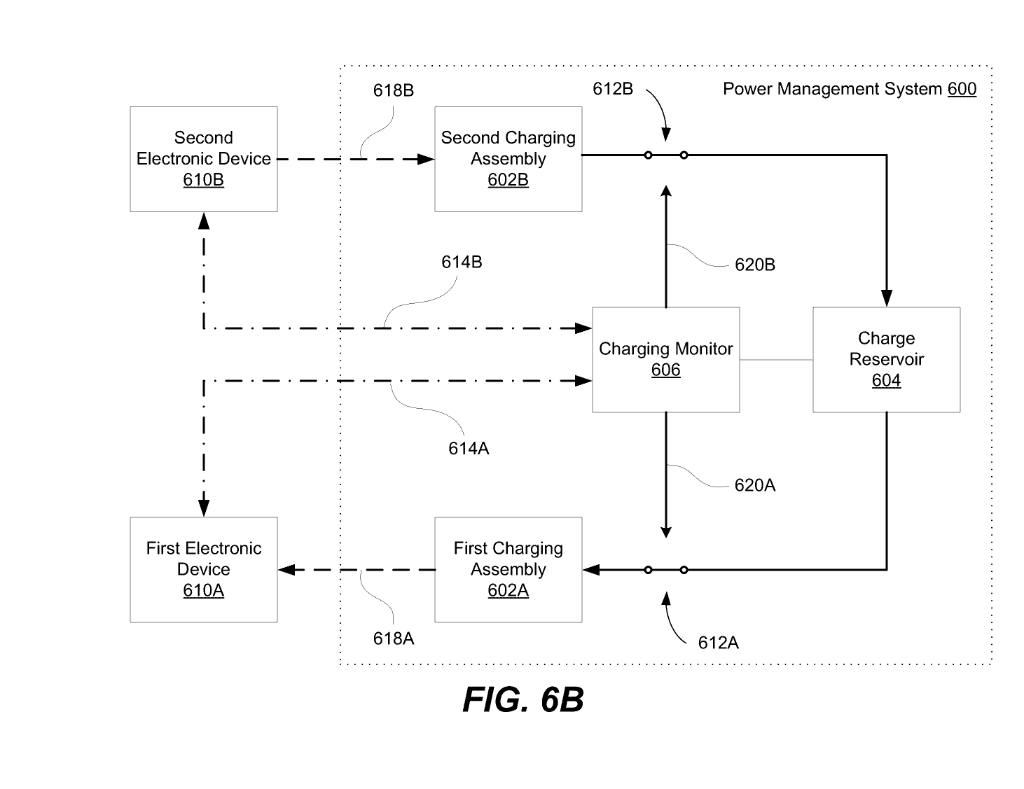

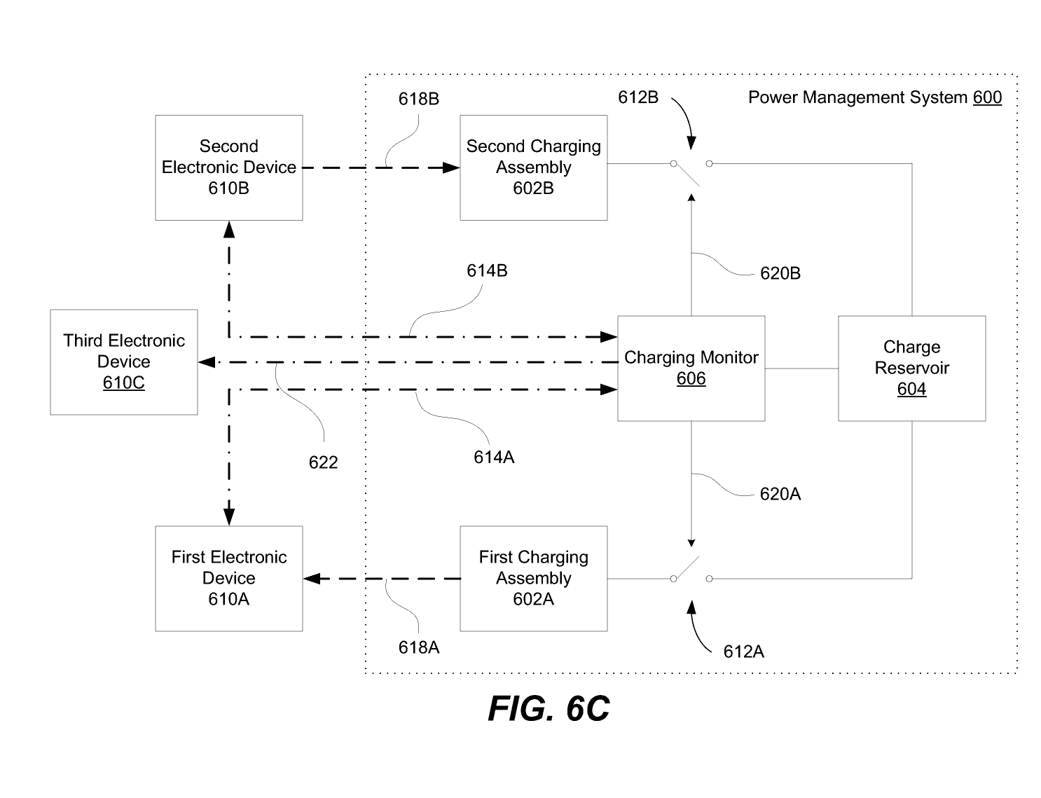

Details of how power can be transferred through power systems according to embodiment of the present invention are discussed herein with respect to FIGS. 5A-5D and 6A-6C. Specifically, FIGS. 5A-5D illustrate a power management system 500 transferring power with a single electronic device. FIGS. 6A-6C illustrate a power management system 600 transferring power with two electronic devices. One skilled in the art will understand that FIGS. 5A-5D and 6A-6C illustrate power transfer for exemplary power management systems and that such illustrated systems are not intended to be limiting. The operation of such power management systems may apply to other power management systems configured to transfer power with more than two electronic devices, for example, without departing from the spirit and scope of the present invention.

A. One Electronic Device Present

As shown in FIG. 5A, power management system 500 may include two charging assemblies 502A and 502B, which allow power management system 500 to transfer power with two electronic devices at one time. However, power management system 500 in FIG. 5A is coupled to only a first electronic device 510A via first charging assembly 502A. In this embodiment, charging assembly 502B may not be coupled to an electronic device. Power management system 500 may be a wireless power management system; thus first charging assembly 502A may be coupled to first electronic device 510A via a wireless transfer connection 518, which is shown as a dashed line. As aforementioned herein, coupling for wireless power management systems, such as power management system 500, may be performed by placing first electronic device 510A in proximity to first charging assembly 502A such that magnetic fields generated by first charging assembly 502A may induce a corresponding current in a receiver coil in electronic device 510. Although description is made for a wireless power management system, the same transfer of power may apply to wired power management systems as well.

Because second charging assembly 502B is not coupled to an electronic device, switch 512B may remain deactivated, thereby preventing transfer of power from charge reservoir 504 to second charging assembly 502B. In embodiments, charging monitor 506 may detect the absence of an electronic device coupling with second charging assembly 502B and thus ensure that second switch 512B remains deactivated. Additionally, charging monitor 506 may detect the presence of first electronic device 510A and initiate communication with first electronic device 510A via communication channel 514 as shown in FIG. 5B. Detection of the presence or absence of an electronic device may be performed by a magnetic sensor/switch, as will be discussed further herein.

In FIG. 5B, charging monitor 506 communicates with first electronic device 510A via a communication channel 514. In some embodiments, charging monitor 506 may use communication channel 514 as an avenue though which it may query first electronic device 510A for charge information pertinent to an implementation of a charge policy. For instance, charging monitor 506 may query first electronic device 510A for its charge state. Once first electronic device 510A receives the query, it may output its charge state to charging monitor 506. Thereafter, charging monitor 506 may receive the charge state of first electronic device 510A.

Once charging monitor 506 receives the charge state of first electronic device 510A, charging monitor 506 may use this information to determine whether power should be transferred to first electronic device 510A. As an example, if the charge state of first electronic device 510A indicates that its amount of charge is lower than a threshold charge state value, then charging monitor 506 may determine that power should be transferred to first electronic device 510A. Accordingly, charging monitor 506 may apply a voltage through activation channel 520 to activate switch 512A as shown in FIG. 5C. When switch 512A is activated, switch 512A may close and thereby allow charge reservoir 504 to transfer power to first charging assembly 502A. Power may then be transferred from first charging assembly 502A to first electronic device 510A.

During power transfer from charge reservoir 504 to first electronic device 510A, charging monitor 506 may periodically query and receive the charge state of first electronic device 510A to monitor the amount of charge present in its internal battery. When the charge state of first electronic device 510A reaches or exceeds the threshold charge state value, then charging monitor 506 may cease applying voltage to switch 512A, in which case switch 512A is opened to prevent transfer of further power between charge reservoir 504 and first charging assembly 502A.

In embodiments, charging monitor 506 may then notify first electronic device 510A that power transfer is complete. As an example, charging monitor 506 may send a notification to first electronic device 510A in the form of a message, such as a pop-up message, a text message, an email, and the like, notifying a user that power transfer is complete. In some embodiments, charging monitor 506 may also send a notification to a second electronic device 510B through communication channel 522 as shown in FIG. 5D. Communication channel 522 may be a wireless connection such as a Bluetooth connection, a WiFi connection, and the like. Second electronic device 510B may or may not be a device that is coupled to a charging assembly, such as second charging assembly 502B. Second electronic device 510B may be a device that is capable of receiving notifications from charging monitor 506. Second electronic device 510B may also be a device that is more easily accessible to the user and thus more likely to successfully notify the user of the completion of power transfer. As an example, second electronic device 510B may be a smart watch, a tablet, a desktop computer, and the like.

Once the notification is sent, the user may be aware of the charge state of first electronic device 510A and decide whether first electronic device 510A should be decoupled from power management system 500. For instance, if the notification notifies the user that the charge state of first electronic device 510A is at the threshold charge state value, the user may decide that there is enough charge in first electronic device 510A, thereby decoupling device 510A from power management system 500. Alternatively, if the threshold charge state value is set at 80% of the internal battery's charge capacity, then the user may decide to leave first electronic device 510A coupled to power management system 500 and instruct charging monitor 506 to charge first electronic device 510A to 100%. Instructing charging monitor 506 may be performed by altering (or overriding) a current charge policy of charging monitor 506 by having first electronic device 510A send a request to charging monitor 506 requesting such an action. In these embodiments, charging monitor 506 may receive the request to alter the current charge policy, and then alter or override the charge policy accordingly.

Power management systems coupled to more than one electronic device may also maximize charging efficiency, as discussed herein with respect to FIGS. 6A-6C.

B. At Least Two Electronic Devices Present

As shown in FIG. 6A, power management system 600 is coupled to two electronic devices: a first electronic device 610A and a second electronic device 610B. Each electronic device may be coupled to a respective charging assembly 602A and 602B. Similar to power management system 500, power management system 600 may be a wireless power management system. Thus, charging assemblies 602A and 602B may be configured for wireless power transfer to first and second electronic devices 610A and 610B. Additionally, first and second electronic devices 610A and 610B may be coupled to charging assemblies 602A and 602B by being placed proximate to respective charging assemblies 602A and 602B such that time-varying magnetic fields generated by charging assemblies 602A and 602B may induce a current in receiving coils in respective electronic devices 610A and 610B.

The charge policy carried out by charging monitor 606 of power management system 600 may be configured to transfer power from second electronic device 610B to first electronic device 610A. It is to be appreciated that the charge policy discussed in reference to power management system 500 for one electronic device (i.e., transferring power from a charge reservoir to electronic devices) may be implemented in power management system 600 for two electronic devices but is not discussed herein for brevity. Power management system 600 is configured to transfer power from second electronic device 610B to first electronic device 610A to highlight the versatility of power management systems according to embodiments of the present invention.

In embodiments, charging monitor 606 may be communicatively coupled to first and second electronic devices 610A and 610B via respective communication channels 614A and 614B. Charging monitor 606 may query and receive a charge state of each respective electronic device through respective communication channels 614A and 614B. Once charging monitor 606 receives the charge states of both electronic devices 610A and 610B, charging monitor 606 may use this information to determine whether second electronic device 610B has sufficient stored power to transfer to first electronic device 610A, and whether first electronic device 610A is in need of power. As an example, charging monitor 606 may compare the charge states of first and second electronic devices 610A and 610B. If first electronic device 610A has a charge state that is less than a first threshold charge state value and if second electronic device 610B has a charge state that is greater than a second threshold charge state value, then charging monitor 606 may initiate its charge policy for transferring power from second electronic device 610B to first electronic device 610A. In embodiments, first and second threshold charge state values may be the same value or different values.

Charging monitor 606 may initiate the transfer of power from second electronic device 610B to first electronic device 610A by applying activation voltages to switches 612A and 612B as shown in FIG. 6B. When the activation voltages are applied, switches 612A and 612B may be activated, i.e., closed, to allow transfer of power between charge reservoir 604 and both first and second electronic devices 610A and 610B. Given that the charge policy may be configured to transfer power from second electronic device 610B to first electronic device 610A, power may transfer from second electronic device 610B to charge reservoir 604 through charging assembly 602B. This power may then transfer from charge reservoir 604 to first electronic device 610A through charging assembly 602A. As a result, first electronic device 610A may receive power transferred from second electronic device 610B.

Once first electronic device 610A is charged to the first threshold charge state value, charging monitor 606 may stop applying activation voltage to switches 612A and 612B. Thus, switches 612A and 612B may be opened to prevent transfer of power between first and second electronic devices 610A and 610B as shown in FIG. 6C. In embodiments, notifications may be sent to first and second electronic devices 610A and 610B through communication channels 614A and 614B, respectively, regarding completion of the power transfer. In some embodiments, a notification may be sent to a third electronic device 610C that is not coupled to charging assemblies 602A and 602B of power management system 600. The third electronic device 610C may be a device that is more easily accessible to the user and thus more likely to successfully notify the user of the completion of power transfer.

Transferring power between devices may be particularly useful when one device is deemed to be more important than the other by a user. For instance, a user may decide that his or her smart phone is more important than his or her tablet. Accordingly, the user may wish to transfer power from the tablet to the smart phone. In embodiments, the user may assign a priority to each device for the charge policy and alter the charge policy to perform transfer of power based upon the assigned priority by sending a request to charging monitor 606 via communication channel 614.

FIGS. 6A-6C discuss transferring power between two devices through a charge reservoir. However, embodiments are not limited to such operations. For instance, a charge policy of a power management system according to embodiments of the present invention may be configured to allocate an amount of power stored in a charge reservoir evenly between more than one electronic device. In other embodiments, a charge policy may be configured to transfer different amounts of power from the charge reservoir to different devices depending on their priority. In yet other embodiments, a charge policy may be configured to transfer power from certain electronic devices to the charge reservoir so that the charge reservoir may be used later as a source of power. As can be appreciated herein, many different types of charge policies may be implemented to take advantage of the versatility of a charging monitor for a power management system according to embodiments of the present invention.

III. Method of Transferring Power with the Charging System

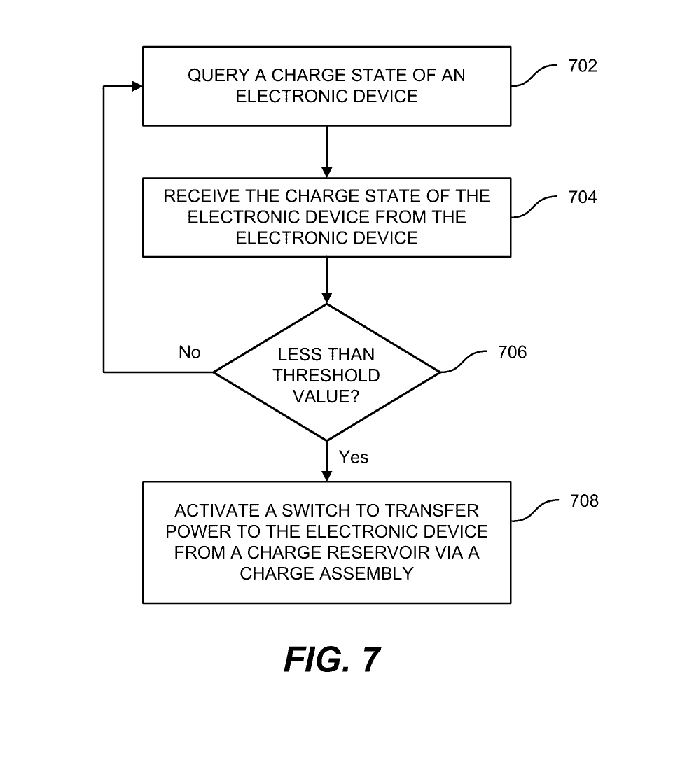

FIG. 7 is a flow chart illustrating an exemplary method of operating a power management system according to embodiments of the present invention. The method shown may be performed to transfer power to an electronic device with a charging monitor as discussed herein. At block 702, a charge state of an electronic device is queried by a charging monitor (e.g., the charge state of first electronic device 510A may be queried by charging monitor 506 as discussed in FIG. 5). The charge state may be a value that represents an amount of charge stored in an internal battery of the electronic device.

At block 704, the charge state of the electronic device may be received by the charging monitor from the electronic device. That is, the electronic device may send information including its charge state to the charging monitor. In embodiments, the information is sent in response to the query from the charging monitor. Thereafter, at block 706, the charging monitor may determine whether the charge state is less than a threshold charge state value. The threshold charge state value may be a value that is set according to a desired goal. From the example aforementioned herein, the threshold charge state value may be set to 80% of a full charge capacity to maximize power transfer efficiency.

If the charge state of the electronic device is greater than or equal to the threshold charge state value, then the charge monitor may query the electronic device for its charge state again at block 702. The charge monitor may query the electronic device if the charge state is greater than or equal to the threshold charge state value because the charge state of the electronic device may be constantly changing, and may drop below the threshold charge state value since it was previously queried. If the charge state of the electronic device is less than the threshold charge state value, then at block 708, the charge monitor may activate a switch to transfer power to the electronic device from a charge reservoir via a charging assembly. For instance, charging monitor 506 may apply a voltage through activation channel 520A to activate switch 512A. When activated, switch 512A may allow voltage to transfer between charge reservoir 504 and first charging assembly 502A to provide power to first electronic device 510A as discussed herein with respect to FIG. 5C.

In some embodiments, method 700 may further include sending a notification to an electronic device. For instance, the charging monitor may send a notification to the electronic device. In other instances, the charging monitor may send a notification to another electronic device that is more likely to be accessed by a user. As an example, charging monitor 506 may send a notification to first electronic device 510A and/or second electronic device 510B as discussed in FIG. 5D.

### IV. Charging Monitor

Power management systems in accordance with embodiments of the present invention may be operated by a charging monitor. The charging monitor may be a nexus that controls individual components of the power management system. In embodiments, the charging monitor itself may include several components.

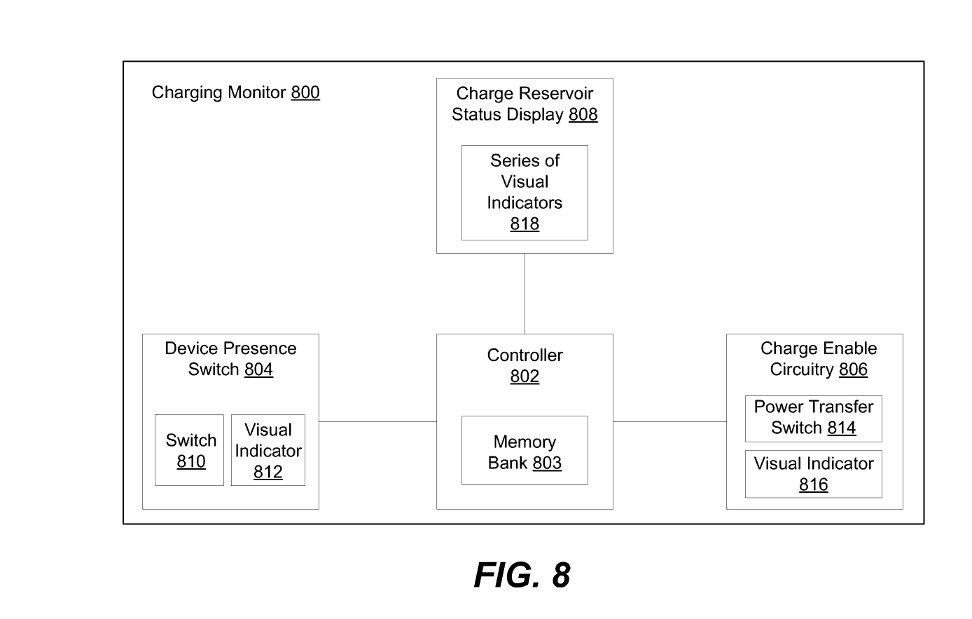

FIG. 8 is a block diagram illustrating an exemplary charging monitor 800 and its components according to embodiments of the present invention. Charging monitor 800 may be the equivalent of charging monitors 106, 206, 306, 406, 506, and 606 discussed herein. Charging monitor 800 may include components such as, but not limited to, a controller 802, a device presence switch 804, charge enable circuitry 806, and a status display 808. Each component may be configured to perform different operations, but may be part of a greater system, such as the power management system, that operates as a single entity to transfer power between a charge reservoir and one or more electronic devices.

A. Controller

In embodiments, controller 802 of charging monitor 800 is a main processing component that runs algorithms to operate the power management system. For instance, controller 802 may be a microcontroller, ASIC, central processing unit (CPU), and the like. The algorithms may correspond to charge policies that establish how power is to be transferred between the electronic devices and the charging reservoir. Information from each component may be sent to controller 802 which may then use this information to decide the next step in the method of transferring power in the power management system.

Controller 802 may include a memory bank 803 within which computer-readable code is stored to instruct controller 802 on how to operate the power management system. The contents stored within memory bank 803 may be adjusted by a user to alter the charge policy. For instance, a user may adjust the threshold charge state value(s), the source of power for an electronic device, which devices are to receive notification, and any other operation of the method of transferring power that a user may wish to change. In embodiments, memory bank 803 and controller 802 may be disposed in the same microchip. In other embodiments, memory bank 803 and controller 802 may be disposed in different microchips.

B. Device Presence Switches

In addition to controller 802, charging monitor 800 may also include a device presence switch 804. Device presence switch 804 may be a sensor that generates a signal when a device is present. In embodiments, device presence switch 804 may include a switch 810 that closes a circuit when a device is present. For example, switch 810 of device presence switch 804 may close a circuit when an electronic device is coupled to a charging assembly of a power management system. When the circuit is closed, a signal may be detected by controller 802, indicating that a device is present. Switch 810 may be any suitable component that can generate a signal when the presence of a device is detected. For instance, switch 810 may be a reed switch, or any other magnetic proximity sensor. In some embodiments, switch 810 may be coupled to a magnetic proximity sensory such as a reed switch included in a charging assembly. A reed switch may be formed of two electrodes that move to make contact with one another when a magnetic field is present. Utilizing a device presence switch allows controller 802 to know when an electronic device is coupled to the power management system.

Referencing FIG. 5A as an example, charging monitor 506 may determine that first electronic device 510A is coupled to first charging assembly 502A when a device presence switch (e.g., switch 804) closes a circuit upon detecting the presence of first electronic device 510A. As a result, charging monitor 506 may know to establish communication channel 514 for querying and receiving the charge state of first electronic device 510A as discussed in FIG. 5B. As further shown in FIG. 5A, the device presence switch may inform charging monitor 506 that an electronic device is not coupled to second charging assembly 502B. Accordingly, charging monitor 506 may keep switch 512B deactivated to prevent wasteful transfer of power from charging reservoir 504 to second charging assembly 502B.

Device presence switch 804 may also include a visual indicator 812. In some embodiments, visual indicator 812 may be a device that generates a visual output when a device is present. Visual indicator 812 may inform a user whether controller 802 detects the presence of an electronic device. As an example, visual indicator 812 may be a light emitting diode (LED) that emits light when the device is present.

Although FIG. 8 illustrates switch 810 as an internal component of charging monitor 800, embodiments are not limited to such configurations. For example, switch 810 may be an external component that is located a distance away from charging monitor 800. In some embodiments, switch 810 may be disposed proximate to a region where an electronic device may be disposed when coupled to a power management system, such as in a charging assembly.

C. Charge Enable Circuitry

In some embodiments, charging monitor 800 may also include charge enable circuitry 806. Charge enable circuitry 806 may be a component of charging monitor 800 that controls the flow of charge from a charge reservoir to an electronic device via a charging assembly. In embodiments, charge enable circuitry 806 may include a power transfer switch 814 (e.g., switch 112, 212, 312, 412, and 512). Power transfer switch 814 may be activated to transfer power between the charge reservoir and the charging assembly. Power transfer switch 814 can be any suitable switch capable of allowing power to transfer across its nodes. For instance, power transfer switch 814 may be a solid state transistor, such as a metal oxide semiconductor field effect transistor (MOSFET), a bipoloar junction transistor (BJT), and the like.

In addition to power transfer switch 814, charge enable circuitry 806 may also include a visual indicator 816. Similar to visual indicator 812, visual indicator 816 may be a device that generates a visual output when power transfer switch 814 is activated. Visual indicator 812 may inform a user whether power is being transferred between a charge reservoir and an electronic device. As an example, visual indicator 812 may be an LED that emits light when power is being transferred between a charge reservoir and an electronic device.

D. Status Display

In embodiments, charging monitor 800 may include a charge reservoir status display 808. Charge reservoir status display 808 may be a user interface that informs a user of the current charge state of a charge reservoir. In embodiments, charge reservoir status display 808 may include a series of visual indicators 818. Series of visual indicators 818 may be an arrangement of electrical devices that can be arranged to emit light in certain patterns. The different patterns may indicate a certain charge state of the charge reservoir. As an example, series of visual indicators 818 may be a line of four LEDs. Each LED may indicate a percentage of charge stored in the charge reservoir. In the case of four LEDs, each LED may represent a quarter of the charge reservoir's capacity. When one LED is lit, charge reservoir status display 808 may indicate to the user that only 25% of the charge reservoir's capacity remains. Accordingly, charge reservoir status display 808 may inform a user whether the charge reservoir has enough power to charge electronic devices according to embodiments of the present invention.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A power management system comprising:
a charge reservoir configured to store power;
a first charger assembly;
a switch coupled to the charge reservoir and the first charger assembly; and
a charging monitor coupled to the switch, the charging monitor configured to:
query a charge state of a first electronic device;
receive the charge state of the first electronic device from the first electronic device;
compare the charge state of the first electronic device to a threshold charge state value; and
activate the switch when the charge state is less than the threshold charge state value, the activation causing power to be transferred from the charge reservoir to the first electronic device via the first charger assembly.

2. The power management system of claim 1 wherein the switch is in a closed position when activated.

3. The power management system of claim 1 wherein the charging monitor is further configured to deactivate the switch when the first electronic device is charged to at least the threshold charge state value.

4. The power management system of claim 1 wherein the charging monitor is further configured to send notifications to the first electronic device.

5. The power management system of claim 4 wherein the notifications inform the first receiving device a charge state of the first electronic device.

6. The power management system of claim 1 wherein the charging monitor is coupled to a second electronic device.

7. The power management system of claim 6 wherein the charging monitor is further configured to send notifications to the second electronic device.

8. The power management system of claim 6 wherein the charging monitor is further configured to transfer power to the second electronic device via a second charger assembly.

9. The power management system of claim 6 wherein the charging monitor is further configured to receive power from the second electronic device.

10. The power management system of claim 1 wherein the charging monitor is further configured to detect a presence of the first electronic device.

11. The power management system of claim 9 wherein the charging monitor is further configured to deactivate the switch when the first electronic device is not detected.

12. The power management system of claim 1 wherein the threshold charge state value is 80% of a full charge capacity of the first electronic device.

13. A method of operating a power management system comprising:
querying, by a charging monitor, a charge state of an electronic device;
receiving, by the charging monitor, the charge state of the electronic device from the electronic device;
determining, by the charging monitor, whether the charge state is less than a threshold charge state value defined by a charge policy; and
activating, by the charging monitor, a switch when it is determined that the charge state is less than the threshold charge state value to transfer power to the electronic device from a charge reservoir via a first charger assembly.

14. The method of claim 13 further comprising deactivating, by the charging monitor, the switch when it is determined that the charge state is at least equal to the threshold charge state value.

15. The method of claim 14 further comprising notifying the electronic device of the charge state.

16. A charging monitor comprising:
a charge enable circuitry configured to activate a power transfer switch upon application of an activation voltage;
a device presence switch configured to determine whether an electronic device is configured to receive power; and
a controller coupled to the charge enable circuitry and the device presence switch, the controller configured to:
query a charge state of the electronic device;
receive the charge state of the electronic device from the electronic device;
determine whether the charge state is less than a threshold charge state value defined by a charge policy; and
activate the power transfer switch when it is determined that the charge state is less than the threshold charge state value by sending the activation signal to the charge enable circuitry, thereby providing power to the electronic device from a charge reservoir via a first charger assembly.

17. The charging monitor of claim 16 wherein the device presence switch is coupled to a magnetic sensor.

18. The charging monitor of claim 17 wherein the magnetic sensor is a reed switch.

19. The charging monitor of claim 16 wherein the charge policy is a user-adjustable policy that determines a charging scheme for the electronic device.
